(19) United States
(12) Patent Application Publication
(10) Pub. No.: US 2026/0306230 A1
(43) Pub. Date: Oct. 8, 2026

(54) Tooth Surface Cleaning Tool, and Powered Tooth Surface Cleaning Device

(71) Applicant: Nishio Co., Ltd., Chiba (JP)

(72) Inventor: Hidetoshi Nishio, Chiba (JP)

(21) Appl. No.: 18/281,666

(22) PCT Filed: Mar. 10, 2022
(86) PCT No.: PCT/JP2022/010469

§ 371 Date: Apr. 2, 2026

(30) Foreign Application Priority Data
Mar. 12, 2021 (JP) 2021-040834

(51) Int. Cl. A61C 17/34; A46B 5/00; A46B 7/04; A46B 9/00; A46B 13/02

(52) U.S. Cl. CPC A61C 17/34; A46B 5/0095; A46B 7/04; A46B 9/005; A46B 13/02

(57) ABSTRACT

It is an object of the invention to provide a tooth surface cleaning tool which does not need individual packaging of melamine resin foam sponge, and can improve the strength of the cleaning tool, capable of improving an effect of removing tooth surface dirt. It is another object of the present invention to provide an electric tooth surface cleaning device which can remove tooth surface dirt very effectively with a simple structure and a simplified operation. The tooth surface cleaning tool (100, 100-2) of the present invention is a tooth surface cleaning tool (100) composed of a melamine resin foam sponge, wherein the melamine resin foam sponge is made by heating and pressurizing a substance containing liquid toothpaste and drying it in a compressed state.

### TECHNICAL FIELD

The present invention relates to a tooth surface cleaning tool for cleaning tooth surface and an electric tooth surface cleaning device provided with the tooth surface cleaning tool.

### BACKGROUND ART

As oral cleaning appliances, toothbrushes and toothpaste are commonly used. Especially, up to now, electric toothbrushes for electric brushing have been proposed (for example, refer to patent documents 1, 2) and have been commercialized. However, it is difficult to remove colored attachments of tobacco, coffee, black tea, green tea and other foods attached to the tooth surface, by using only usual toothbrushes and toothpaste.

In order to remove colored attachments of tobacco varnish, coffee, black tea, green tea and other foods attached to the tooth surface, there are, for example, tooth cleaning tools (tooth surface cleaning tools) using melamine resin foam sponges as shown in Patent Documents 3-5. The tooth cleaning tools described in Patent Document 3 is made by sealing a melamine resin foam sponge impregnated with liquid toothpaste into a packaging container such as a packaging bag.

### PRIOR ART DOCUMENTS

### Patent Documents

Patent Document 1: Japanese Patent Application Laid-Open No.2014-176742

Patent Document 2: Japanese Patent Application Laid-Open No.2018-183280

Patent Document 3: Japanese Utility Model Registration No. 3170648

Patent Document 4: Japanese Patent Application Laid-Open No.2007-97714

Patent Document 5: Japanese Patent Application Laid-Open No.2007-82777

### SUMMARY OF THE INVENTION

### Problem to be Solved by the Invention

However, since the tooth surface cleaning tool described in Patent Document 3 is a melamine resin foam sponge impregnated with liquid toothpaste, it must be stored and distributed in a sealed packaging container such as a packaging bag. Therefore, in the manufacturing process, it is necessary to put the melamine resin foam sponge into the packaging container for sealing. In this way, in order to reduce the manufacturing cost, it is desirable to omit a step of putting the melamine resin foam sponge into a packaging container for sealing.

In addition, if the melamine resin foam sponge impregnated with liquid toothpaste is packaged separately (one by one) in packaging containers, it is necessary to open the separate packages when using. Therefore, it takes a lot of time to open the packages in using. Besides, there are also inconveniences such as garbage generated every time a package is opened. Moreover, because the melamine resin foam sponge for use in cleaning the tooth surface is used by strongly rubbing the tooth surface, it will deteriorate due to surface collapse or fiber breakage after being used once or several times. Accordingly, in order for the melamine resin foam sponge to be reused, it is necessary to have a higher strength to resist the friction against the tooth surface. In addition, it is also required to have a structure that can remove the dirt on the tooth surface more simply and effectively by rubbing the tooth surface.

In addition, as shown in Patent Documents 4 and 5, the conventional melamine resin foam sponge for tooth surface cleaning is used by manually rubbing it against the tooth surface by holding it with hands or fingers or attaching it to a hand-held tool. However, if you are not used to manually rubbing the melamine resin foam sponge against the tooth surface, it will be very difficult for an elderly person or a child in using the hand-held cleaning tool, and it will be difficult to clean the whole tooth surface evenly.

The present invention has been accomplished in view of the above-mentioned actual situation, and it is an object of the invention to provide a tooth surface cleaning tool which does not need separate packaging of melamine resin foam sponge, and can improve the strength of the cleaning tool, capable of further improving an effect of removing surface dirt. It is another object of the present invention to provide an electric tooth surface cleaning device which can remove tooth surface dirt very effectively with a simple structure and a simplified operation.

### Means for Solving Problems

In order to achieve the above object, the tooth surface cleaning tool (100, 100-2) of the present invention is a tooth surface cleaning tool composed of a melamine resin foam sponge, wherein the melamine resin foam sponge is formed by heating and pressurizing a material containing liquid toothpaste and drying it in a compressed state.

In addition, regarding the tooth surface cleaning tool of the present invention, the liquid toothpaste may also contain polyphosphate or polyethylene glycol. In addition, liquid toothpaste can also contain flavoring agents or fluorine compounds.

Besides, regarding the tooth surface cleaning tool of the present invention, the melamine resin foam sponge may also be a sponge dried by vacuum drying or freeze drying. In addition, the melamine resin foam sponge is preferably compressed to about ¼ of its original volume by the above pressurization.

According to the tooth surface cleaning tool of the present invention, the melamine resin foam sponge may be made by heating and pressurizing a material containing liquid toothpaste and drying it in a compressed state, thereby making it possible to achieve the following effects.
(1) Since melamine resin foam sponge is made by drying a material containing liquid toothpaste through heating, it is not necessary to keep the material in a sealed state in packaging containers such as packaging bags as in the past. Therefore, in the manufacturing process, there is no need to put the melamine resin foam sponge into the packaging container for sealing. In this way, since it is possible to omit the sealing process of putting the melamine resin foam sponge into the packaging containers, the manufacturing cost can be reduced. In addition, since there is no need to individually open each respective packages when in use, the time for opening the packages when in use can be reduced, and the garbage of the packaging container will not be generated when in use.
(2) Since the melamine resin foam sponge is formed by pressurizing and compressing, and will not be broken, thus improving the tooth cleaning efficiency and tool durability, and reducing the sizes of holes after compression.

In addition, the present invention is also an electric tooth surface cleaning device (1) for cleaning teeth, which comprises a main body (2) provided with a main body case (2A) and a tapering neck portion (2B) extending from one end of the main body case (2A); a head part (3) rotatably provided at the front end of the neck portion 2B; a tooth surface cleaning tool 100-2 detachably mounted on the mounting table (5) of the head part (3); a battery (7) and a motor (8) built in the main body case (2A); and a conversion mechanism for converting the rotation of the motor (8) into the rotary motion or reciprocating rotary motion of the mounting table (5). The tooth surface cleaning tool (100-2) is provided with any one of the above-discussed structures of the present invention.

Using the electric tooth surface cleaning device of the present invention, a user can easily and effectively remove the tartar attached to the surface of the teeth using the tooth surface cleaning tool, simply by inserting the head part side of the electric tooth surface cleaning device into the mouth, moving the cleaning tool in the mouth while abutting the same (which is the tooth surface cleaning tool mounted on the rotating or reciprocating head part) against the tooth surface. In this way, it is possible to effectively remove the dirt on the tooth surface with a simple structure and a simplified operation.

In addition, the electric tooth surface cleaning device (1) may be provided with a mounting unit (6) which can detachably attach the tooth surface cleaning tool (100-2) to the mounting table (5). Here, the mounting unit (6) is a touch fastener.

According to this structure, since it is possible to detachably attach the tooth surface cleaning tool to the mounting table with a simple and inexpensive structure, it is possible to very easily and quickly replace the tooth surface cleaning tool composed melamine resin foam sponges (disposable several times to more than ten times). Meanwhile, when the electric tooth surface cleaning device is used, the tooth surface cleaning tool composed of melamine resin foam sponge can be reliably kept on the mounting table, making it possible to effectively clean the tooth surface.

In addition, regarding the electric tooth surface cleaning device (1), the conversion mechanism for converting the rotation of the electric motor (8) into the rotation of the mounting table (5) may be formed by the bevel gears (20, 22) for converting the rotation direction of the output shaft (8a) of the electric motor (8) into a direction perpendicular to the output shaft.

According to the above structure, since the rotating direction of the output shaft of the motor is converted into the direction perpendicular to the output shaft through the bevel gears and then transmitted to the head part, it becomes possible to rotate the head part in the normal rotating direction (the rotating direction orthogonal to the rotating direction of the output shaft of the motor), thereby making it possible to easily and exactly remove the tongue coating attached to the tongue.

In addition, in the electric tooth surface cleaning device (1), the conversion mechanism for converting the rotation of the electric motor (8) into the reciprocating rotary motion of the mounting table (5) comprises a first mechanism for converting the rotation of the output shaft (8a) of the electric motor (8) into the reciprocating linear motion of the rod (13)

Here, the first mechanism includes: a gear 9 combined with the output shaft 8a of the motor 8; a ring gear 10 meshed with the gear 9; and an eccentric cam (not shown) whose rotation center is a point eccentric from the rotation center of the ring gear 10. The second mechanism has a swing arm (16), the swing end of which is rotatably fitted in a long hole (5a) formed in the radial direction of the head part (3), one point of the base end is rotatably connected with the front end of the rod (13), and the other point of the base end is supported to be able to swing about a swing shaft (18).

According to the above structure, the rotation of the output shaft of the motor is converted into the reciprocating linear motion of the rod through the first mechanism, and the reciprocating linear motion of the rod is converted into the reciprocating rotational motion of the head part (mounting table) through the second mechanism. Therefore, the rotation of the output shaft of the motor is converted into the reciprocating rotary motion of the head part through the first and second mechanisms.

However, the above reference numerals in brackets are those indicating (for reference) figure reference numerals representing constituent elements corresponding to the embodiments described later.

### Effect of Invention

According to the tooth surface cleaning tool of the present invention, the melamine resin foam sponge does not need to be packaged individually and separately, and it is possible to improve the strength of the cleaning tool and to more effectively remove the dirt on the tooth surface as compared with the traditional cleaning devices. In addition, according to the electric tooth cleaning device having the tooth surface cleaning tool of the present invention, it is possible to remove dirt on the tooth surface with a simple structure and simplified operation.

### BRIEF DESCRIPTION OF DRAWINGS

FIG. 1 is a perspective view showing a tooth surface cleaning tool according to a first embodiment of the present invention.

FIG. 2 is a perspective view showing an electric tooth surface cleaning device according to a second embodiment of the present invention.

FIG. 3 is a view showing a tooth surface cleaning tool mounted on the head part (mounting table) of the electric tooth surface cleaning device.

FIG. 4 is a schematic diagram showing a configuration of a driving system of an electric tooth surface cleaning device.

FIG. 5 is a schematic diagram showing the structure of a driving system of an electric tooth surface cleaning device according to a third embodiment of the present invention.

FIG. 6 is a diagram showing an operation of the head part (mounting table) of the electric tooth surface cleaning device according to the third embodiment.

### EMBODIMENTS FOR CARRYING OUT THE INVENTION

Embodiments of the present invention will be described below with reference to the accompanying drawings.

### First Embodiment: Tooth Surface Cleaning Tool

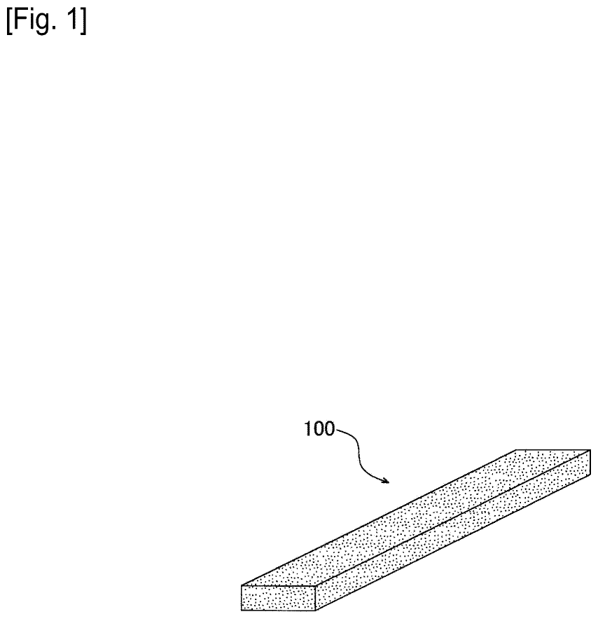

FIG. 1 is a perspective view showing a tooth cleaning tool according to a first embodiment of the present invention. The tooth surface cleaning tool 100 shown in the figure is a tooth surface cleaning tool which is formed by heating and pressurizing a melamine resin foam sponge impregnated with liquid toothpaste and drying the same in a compressed state.

Melamine resin foam sponge can be impregnated with water or liquid toothpaste by having numerous continuous pores. In addition, depending on the material characteristics, melamine resin foam sponge can effectively remove colored substances attached to the tooth surface. Since melamine resin foam sponge is soft, it can be used for oral cleaning without damaging teeth and gums.

In addition, when manufacturing the melamine resin foam sponge, it is possible to increase the density of the sponge. In order to increase the density of sponge, the melamine resin foam sponge is pressurized and heated at the same time, so as to crush bubbles and walls isolating bubbles. Compared with the melamine sponge without being pressurized and heated, the density of the melamine resin foam sponge thus obtained is 1.5 to 15 times higher. The high-density melamine resin foam sponge is not easy to wear away and is more suitable for oral cleaning. In addition, the pressurization may be carried out by pressing with a die that forms a pattern of concavities and convexities such as ripples on the surface during pressurization. If the surface forms a concave-convex pattern, the dirt attached to the tooth surface can be removed more effectively.

The effective ingredients added in the liquid toothpaste can effectively clean the mouth, prevent halitosis, prevent tartar deposition, prevent periodontitis, gingivitis and prevent dental caries.

In addition, adding coolants and spices into liquid toothpaste can improve the refreshing feeling when using. Specific substances are listed below, but the effective components are not limited to these.

As the effective ingredients to be added into the liquid toothpaste, it is possible to use condensed phosphate, detergent, bleaching agent, anti-inflammatory agent, antibacterial agent, surfactant and fluorine compound, with the usable sorts of these substance being one or more, preferably two or more, more preferably with all of these substances being used. Condensed phosphates include polyphosphate, ultra phosphate, metaphosphate and pyrophosphate. Detergents include polyethylene glycol, polyvinylpyrrolidone, phytic acid, sodium hydrogen phosphate, sodium phosphate and zeolite. Bleaching agents include hydrogen peroxide, urea peroxide, calcium peroxide and sodium chlorite. The anti-inflammatory agent includes allantoin, 8-aminocaproic acid, dipotassium glycyrrhizinate, β-glycyrrhizic acid, ascorbic acid, vitamin E and sodium azulene sulfonate. Antibacterial agents include isopropylmethylphenol, chlorhexidine hydrochloride, triclosan, hinokitiol, cetylpyridinium chloride, sodium copper chlorophyllin, benzalkonium chloride, depotium chloride, benzethonium chloride, alkyldiaminoethylglycine hydrochloride, pyridoxine hydrochloride, lysozyme chloride, and catechin. Surfactants include polyoxyethylene lauryl ether and sodium lauroyl sarcosine. Fluorine compounds include sodium fluoride, sodium monofluorophosphate, and stannic fluoride.

Liquid toothpaste can also contain thickener, solvent, perfume and sweetener. The thickener can be sodium carboxymethyl cellulose. The solvent can be ethanol and polyoxyethylene solidified castor oil. Examples of spices include mint spices. Examples of sweeteners include xylitol and saccharin sodium, which also have the effect of preventing dental caries.

In this embodiment, the liquid toothpaste may also contain polyphosphate. Using liquid toothpaste containing polyphosphoric acid for cleaning the mouth, it is possible to easily remove the colored substances from the tooth surface, prevent the adhesion of new colored substances, and promote the blood circulation of gums. When the liquid toothpaste is 100 parts by weight, the addition amount of polyphosphoric acid is 0.1 parts by weight or more and 20 parts by weight or less, more preferably 0.5 parts by weight to 5 parts by weight.

In this embodiment, the liquid toothpaste may also contain polyethylene glycol. Oral cleaning with liquid toothpaste added with polyethylene glycol can easily remove the attached substances from the tooth surface. When the liquid toothpaste is 100 parts by weight, the addition amount of polyethylene glycol is 0.5 parts by weight or more and 20 parts by weight or less, more preferably from 1 part by weight to 10 parts by weight.

Moreover, in this embodiment, the liquid toothpaste may also contain a flavoring agent. If the liquid toothpaste contains the flavoring agent, the tooth surface cleaning tool of this embodiment will have an effect of preventing bad breath and has a function of imparting a fragrance to the oral cavity. When the amount of liquid toothpaste is 100 parts by weight, the addition amount of flavoring agent is 0.01 parts by weight or more and 5 parts by weight or less, more preferably from 0.1 parts by weight to 1 part by weight.

In this embodiment, the liquid toothpaste may also contain a fluorine compound. Examples of fluorine compounds include sodium fluoride and sodium mono fluorophosphate. If the liquid toothpaste contains fluorine compounds, the tooth surface cleaning tool of this embodiment will have a function of coating the tooth surface with fluorine. When the amount of liquid toothpaste is 100 parts by weight, the addition amount of fluorine compound may be 0.01 parts by weight or more and 5 parts by weight or less, more preferably from 0.1 parts by weight to 1 part by weight.

Next, the liquid toothpaste properly containing the above effective components is caused to impregnate throughout a melamine resin foam sponge. Specifically, the liquid toothpaste is put into a container, and the melamine resin foam sponge is impregnated therein. The soaking time is, for example, from 1 minute to 2 hours, and more preferably from 5 minutes to 1 hour. In addition, the impregnation temperature is 5°C to 40°C, more preferably 15°C to 30 °C

The melamine resin foam sponge impregnated with liquid toothpaste is dried through a drying process. As a drying step here, for example, the melamine resin foam sponge impregnated with liquid toothpaste can be dehydrated by a method such as vacuum drying or freeze drying.

Melamine resin foam sponge is cut into appropriate size for use before or after the process of dipping melamine resin foam sponge in liquid toothpaste and the process of drying. For example, melamine resin foam sponge can be cut into a cuboid shape with a major axis of 4 cm, a minor axis of 1 cm and a thickness of about 0.5 cm.

In addition, the tooth surface cleaning tool 100 made of dried melamine resin foam sponge may be sterilized through a sterilization process if necessary. By virtue of sterilization, the proliferation of bacteria in melamine resin foam sponge can be prevented. In addition, through the sterilization process, the melamine resin foam sponge can be pressurized and heated, and the melamine resin foam sponge with higher density can be obtained.

Next, description will be given to explain the sequence of using the tooth surface cleaning tool 100 composed of the melamine resin foam sponge according to this embodiment. First, the tooth surface cleaning tool 100, which is composed of the melamine resin foam sponge of this embodiment, is recovered from a dry state to a water-containing state by soaking or watering with water immediately before use. In this state, the cleaning too is held by hand (finger), or installed on a special fixture to hold the fixture and rub the tooth surface to clean the tooth surface.

As described above, according to the tooth surface cleaning tool 100 of this embodiment, since the melamine resin foam sponge is obtained by heating, pressurizing a material containing liquid toothpaste (followed by drying in a compressed state), it is possible to produce the following advantages effects.

In this way, since the melamine resin foam sponge is made by drying a material containing liquid toothpaste (by heating), it does not need to be kept and transported in a state of being sealed in packaging containers such as packaging bags (as in the past).

Therefore, in the manufacturing process, there is no need to put the melamine resin foam sponge into the packaging container for sealing. Accordingly, it is possible to omit a step of putting the melamine resin foam sponge into the packaging container for sealing, so that the manufacturing cost can be reduced. In addition, since there is no need to open each respective packages when in use, it is possible to omit a time and an operation for opening the respective packages, thereby avoiding garbage from packaging containers. Besides, since the melamine resin foam sponge is compressed by being pressurized, it is possible to obtain advantageous effects that the foam sponge is not easy to break, easy to be cleaned, easy to be improved in its durability, and possible to reduce the sizes of sponge holes after being compressed.

### Second Embodiment: Electric Tooth Surface Cleaning Device

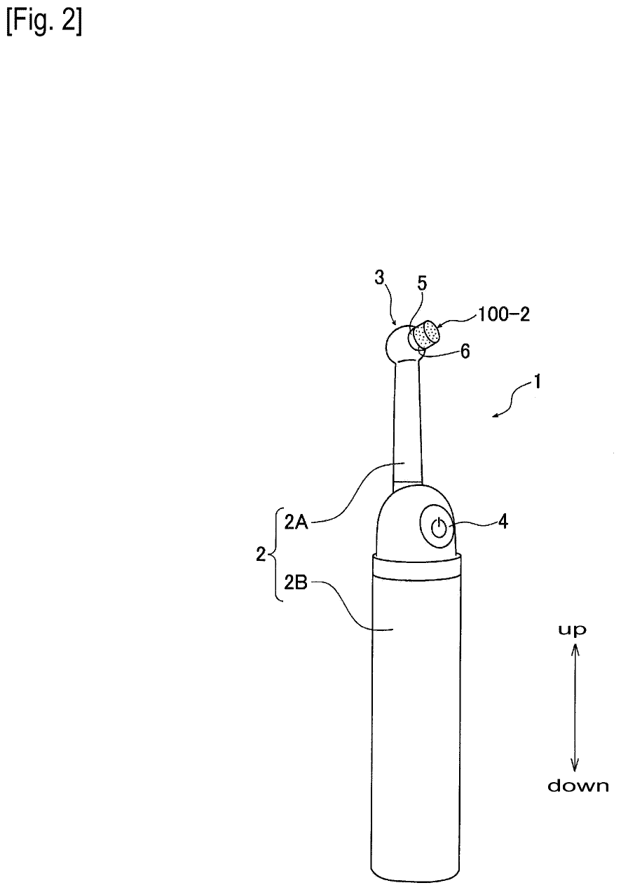

Next, description will be given to explain a second embodiment of the present invention. FIG. 2 is a perspective view showing an electric tooth surface cleaning device according to a second embodiment of the present invention. The electric tooth surface cleaning device 1 of this embodiment is mainly used for electrically removing dirt such as tartar attached to the tooth surface.

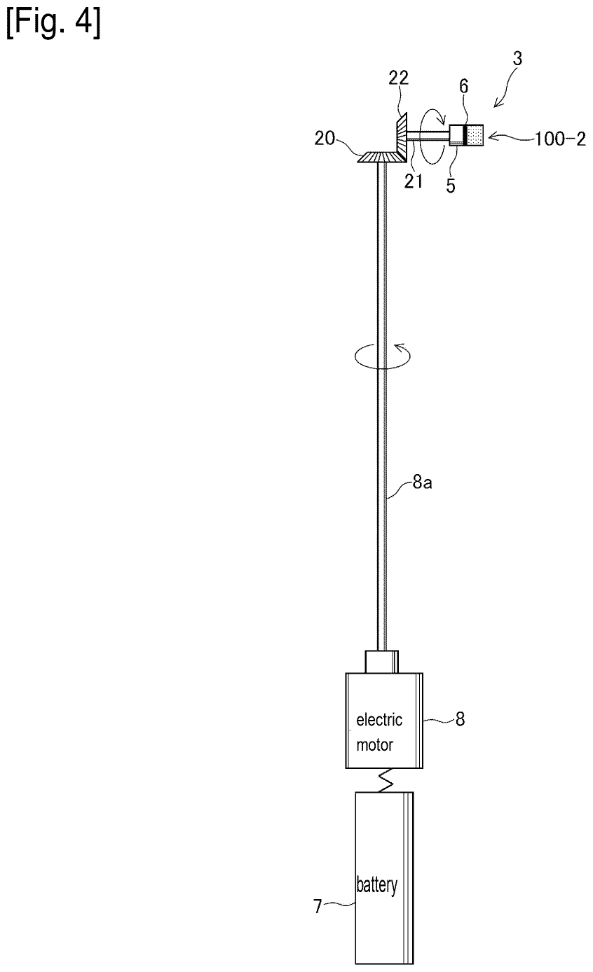

As shown in FIG. 2, the electric tooth surface cleaning device 1 is composed of a main body 2, a head part 3 rotatably arranged at the front end of the main body 2, a driving system (see FIG. 4) for rotationally driving the head part 3, and a tooth surface cleaning tool 100-2 made of melamine resin foam sponge mounted on the head part 3. In the following description, the arrow directions shown in FIG. 2 are “up and down” and “front and back”.

The main body 2 is composed of a bottomed cylindrical main body case 2A and a tapered cylindrical neck portion (handle) 2B extending upward from the upper end of the main body case 2A, and a head part 3 provided at the upper end of the neck portion 2B. Here, the main body 2 is made of a resin such as polyethylene terephthalate (PET) and polyacetal (POM), and the neck port 2B is detachably connected to the main body case 2A. In addition, as shown in FIG. 2, an ON/OFF switch 4 for rotating/stopping the head part 3 (mounting table 5) is provided at an approximately middle height position of the main body 2.

In addition, as shown in FIG. 2, the head part 3 is provided with a substantially cylindrical mounting table 5 that is rotatably supported. In this way, a tooth surface cleaning tool 100-2 made of melamine resin foam sponge can be detachably mounted on the mounting table 5. The outer diameter of the mounting table is set to be 0.7-1.0 cm.

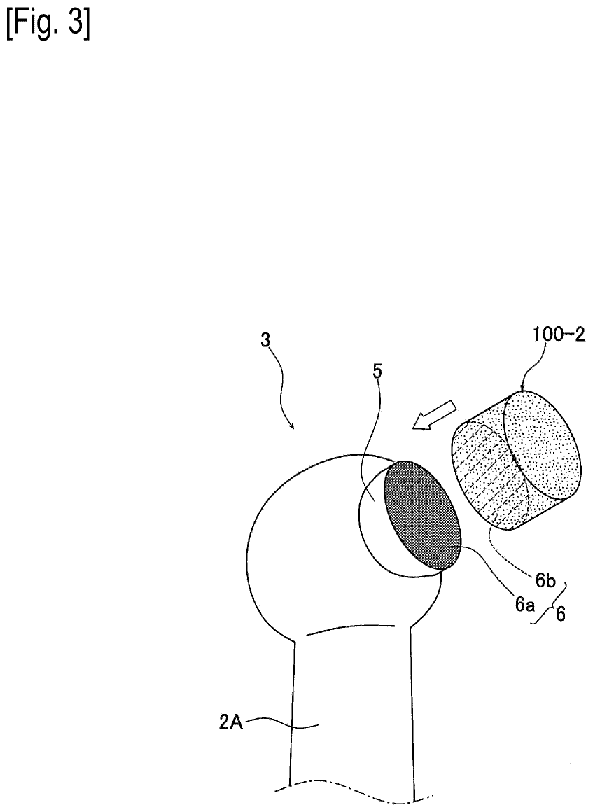

Next, description will be given to explain a tooth surface cleaning tool 100-2 attached to a head part 3. FIG. 3 is a diagram showing the head part and a tooth surface cleaning tool mounted on the head part. The tooth surface cleaning tool 100-2 shown in this figure is a tooth surface cleaning tool which is made by heating and pressurizing a melamine resin foam sponge impregnated with liquid toothpaste and drying it in a compressed state. The method of manufacturing the cleaning tool and the composition of the cleaning tool are the same as the tooth surface cleaning tool 100 of the first embodiment.

The melamine resin foam sponge forming the tooth surface cleaning tool 100-2 of the present embodiment is cut into a shape and a size for being mounted on the mounting table 5 before or after the step of dipping the same in the liquid toothpaste and the drying step. For example, a melamine resin foam sponge can be cut into a substantially cylindrical shape with its longer axis being about 1 cm and its diameter being about 1 cm. On the other hand, such a size and a shape of the melamine resin foam sponge is only an example, and should not be limited by the above description, as long as it is suitable to be attached to the mounting table 5 and suitable for use.

In addition, the tooth surface cleaning tool 100-2 of the present embodiment has attachment means 6 for being detachably attached to the mounting table 5 of the head part 3. Here, the attachment means 6 can be a touch fastener or a double-sided adhesive tape. As shown in the figure, when the attachment means is a touch fastener, one piece (male member or female member) 6a of the fastener is provided on the upper end face of the head part 3, and the other piece (female member or male member) 6b of the fastener is provided on the lower end face of the tooth surface cleaning tool 100-2. Then, the tooth surface cleaning tool 100-2 is attached to the mounting table 5 of the head part 5 by sticking the other piece 6b to one piece 6a of the fastener. In addition, where the attachment means is a double-sided adhesive tape, although not shown in the drawings, the double-sided adhesive tape may be provided on the lower end face of the tooth surface cleaning tool 100-2. Then, the release paper of the double-sided adhesive tape provided on the lower end surface of the tooth surface cleaning tool 100-2 is peeled off to expose the adhesive surface, and in this state, the adhesive surface is pressed against the upper end surface of the mounting table 5, so that the tooth surface cleaning tool 100-2 can be attached to the upper end surface of the mounting table 5.

On the other hand, when removing the tooth surface cleaning tool 100-2 mounted on the mounting table 5, the tooth surface cleaning tool 100-2 is pinched and pulled by hands or fingers, so as to be separated from the mounting table 5, thereby releasing an attachment (joining) based on the attachment means 6 consisting of touch fasteners or double-sided adhesive tape.

Next, description will be given to explain the structure of a drive system equipped in the electric tooth surface cleaning device 1. FIG. 4 is a schematic diagram showing the configuration of the drive system of the electric tooth surface cleaning device. In the electric tooth surface cleaning device 1 of the present embodiment, the head part 3 is continuously rotationally driven in one direction.

As shown in FIG. 4, a battery 7 serving as a power supply and a motor 8 which is rotationally driven by electric power supplied from the battery 7 are housed in a vertical state in the main body case 2A (see FIG. 2) of the main body 2. An output shaft (motor shaft) 8a extending upward from the center of the motor 8 is extending toward the head part 3 through the neck portion 2B of the main body 2, and a bevel gear 20 is attached to the upper end of the output shaft 8a. As the battery 7, it is possible to use a disposable primary battery or a rechargeable secondary battery.

In addition, the mounting table 5 of the head part 3 is coupled to a rotating shaft 21 arranged in the front-rear direction orthogonal to the output shaft 8a of the motor 8, and a bevel gear 22 is attached to the front end of the rotating shaft 21, while the bevel gear 22 and the bevel gear 20 are engaged with each other. Here, two bevel gears 20 and 22 that mesh with each other constitute a conversion mechanism for converting the rotation direction of the output shaft 8a of the motor 8 to a direction perpendicular to the output shaft.

Next, description will be given to explain a procedure for using the electric tooth surface cleaning device 1 configured as described above.

First, the tooth surface cleaning tool 100-2, which is made of melamine resin foam sponge of the present embodiment, is restored from a dry state to a water-containing state by soaking or watering with water immediately before use, similar to a situation associated with the tooth surface cleaning tool 100 according to the first embodiment. In this state, the tooth surface cleaning tool 100-2 is attached to the head part 3 by the attachment means 6 such as touch fastener.

Then, when the user holds the main body case 2A of the electric tooth surface cleaning device 1 and presses the ON/OFF switch 4, electric power is supplied to the motor 8 from the battery 7, and the motor 8 is started, so that the output shaft 8a of the motor 8 rotates. Then, the rotating direction of the output shaft 8a is converted into a direction perpendicular to the output shaft by the bevel gears 22 and 20 (together constituting the conversion mechanism) and transmitted to the rotating shaft 21 and the head part 3 connected thereto, thereby driving these components to cause them to rotate.

In the above-mentioned state, when the user inserts the head part 3 side of the electric tooth surface cleaning device 1 into the mouth and moves the tooth surface cleaning tool 100-2 mounted on the mounting table 5 of the head part 3, it is easy for the tooth surface cleaning tool 100-2 to remove dirt such as tartar. On the other hand, since the tooth surface cleaning tool 100-2 of the present embodiment (which is made of melamine resin foam sponge), is a disposable goods that can be used for several times to more than ten times, the tooth surface cleaning tool 100-2 after this number of uses will be removed from the mounting table 5 and discarded.

Further, in the present embodiment, if the motor 8 is one capable of rotating forward and backward, and if the polarity of the motor 8 is alternately switched by a switching mechanism such as a switch circuit, it is possible for the mounting table 5 of the head part 3 to be rotated forward and backward.

As described above, using the electric tooth surface cleaning device 1 of the present embodiment, it is possible to easily and effectively remove the dirt from the tooth surface using the tooth surface cleaning tool 100-2, by only inserting the head part 3 side of the electric tooth surface cleaning device 1 into the mouth and moving the tooth surface cleaning tool 100-2 mounted on the rotating or reciprocating mounting table 5 while abutting the same against the tooth surface. In this way, it is possible to very effectively remove the tartar from the tooth surface, using only a simple configuration and simplified operation.

That is to say, since the tooth surface cleaning tool 100-2 attached to the mounting table 5 of the head part 3 is a tooth surface cleaning tool composed of a melamine resin foam sponge, it is possible to effectively remove the adhesive substance on the tooth surface by rubbing the melamine resin foam sponge against the tooth surface. In addition, using the electric tooth surface cleaning device 1, it is possible to obtain the following advantages effects. Namely, since it is not necessary to perform a skilled operation as compared with a manual tooth surface cleaning tool or a manual tooth surface cleaning device, it is possible to remove dirt such as tartar from tooth surface even if the cleaning device is operated by a child, a woman or an old person.

In addition, since the electric tooth surface cleaning device 1 of the present embodiment is equipped with the attachment means 6 capable of detachably attaching the tooth surface cleaning tool 100-2 made of melamine resin foam sponge to the mounting table 5, and since the attachment means 6 is a touch fastener or double-sided adhesive tape, it is possible for the tooth surface cleaning tool 100-2 to be detachably attached to the mounting table 5 using a simple and inexpensive structure. Therefore, it is possible to easily and quickly replace the tooth surface cleaning tool 100-2 made of melamine resin foam sponge (which is usually disposal after being used few times to more than ten times). Meanwhile, when using the electric tooth surface cleaning device 1, it is possible to exactly hold the tooth surface cleaning tool 100-2 made of melamine resin foam sponge on the mounting table 5, thereby rendering it possible to more effectively clean the tooth surface.

### Third Embodiment

Next, description will be given to explain a third embodiment of the present invention. However, in the descriptions of the third embodiment and the corresponding drawings, the same or equivalent components as those in the second embodiment will be denoted by the same reference numerals, and the detailed descriptions thereof will be omitted. In addition, matters other than those described below and matters other than those shown in the drawings will be the same as those in the second embodiment.

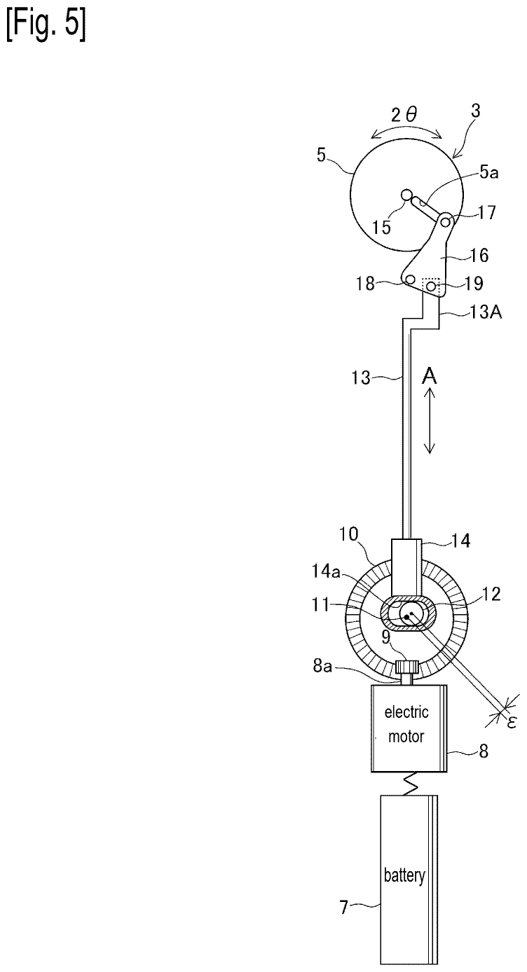

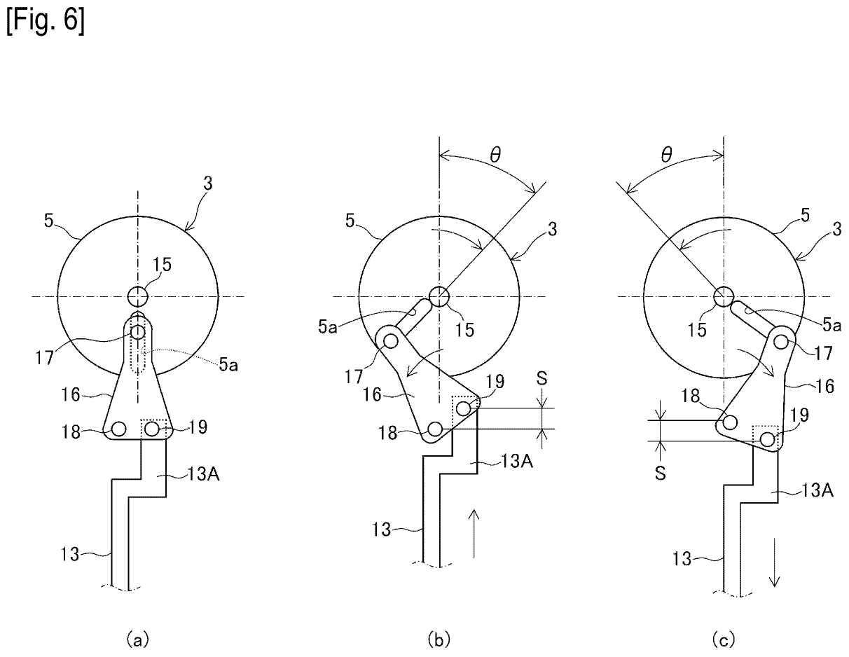

FIG. 5 is a schematic diagram showing the configuration of a driving system of an electric tooth surface cleaning device according to a third embodiment of the present invention. FIGS. 6 (a) to 6 (c) are diagrams showing the action (reciprocating rotary motion) of the head part of the electric tooth surface cleaning device. Compared with the electric tooth surface cleaning device of the first embodiment, the electric tooth surface cleaning device of this embodiment is different only in the structure of the driving system for driving the mounting table 5 of the head part 3, while other structures are the same as the first embodiment.

As shown in FIG. 5, in the electric tooth surface cleaning device of the present embodiment, a gear 9 is attached to the upper end of an output shaft (motor shaft) 8a extending upward from the center of the electric motor 8, and this gear 9 meshes with a ring gear 10.

The ring gear 10 is accommodated in the upper part of the main body case 2A, and is rotatably supported about a rotating shaft 11 arranged in the front-rear direction (perpendicular to the paper in FIG. 5). Moreover, an eccentric cam 12 with its center being coupled to the rotating shaft 11 at a position (which is eccentric from the center of the rotating shaft 11). In addition, a driven member 14 is connected to the lower end of a rod 13 inserted into the neck portion 2B of the main body 2 in the vertical direction, while the eccentric cam 12 is engaged in a long hole 14a formed in the driven member 14.

Here, the gear 9, the ring gear 10, the eccentric cam 12 and the driven member 14 together form a first mechanism for converting the rotation of the output shaft 8a of the motor 8 into a reciprocating linear motion of the rod 13 in the up-and-down direction (an arrow A direction in FIG. 5).

As shown in FIG. 5, the center of the mounting table 5 of the head part 3 is rotatably supported by a shaft 15 arranged in the front-rear direction, and a long hole 5a is formed in the radial direction on the back surface of the mounting table 5. In addition, a roller 17 provided at the upper end (swing end) of the swing arm 16 is movably fitted into this long hole 5a. Further, the lower end portion (base end portion) of the swing arm 16 is pivotally attached to the neck portion 2B of the main body 2 in a swingable manner through a swing shaft 18.

On the other hand, a bent portion 13A is formed at the upper end of the rod 13, and such an upper end of the bent portion 13A is connected to the lower end (base end) of the swing arm 16 through a pin 19.

Here, the swing arm 16 forms a second mechanism for converting the reciprocating linear motion of the rod 13 in the up-and-down direction into the reciprocating rotary motion of the head part 3 (alternating forward and reverse motions within a predetermined angular range).

When the user holds the main body case 2A of the electric tooth surface cleaning device 1 and presses the ON/OFF switch 4, an electric power will be supplied to the motor 8 from the battery 7, and the motor 8 can thus be started, thereby starting the rotation of the output shaft 8a of the motor 8. In this way, the rotation of the output shaft 8a will be decelerated through the gear 9 and the ring gear 10, and be transmitted to the rotating shaft 11, thereby starting the rotation of the rotating shaft 11 and the eccentric cam 12 connected thereto.

As described above, when the eccentric cam 12 rotates in the long hole 14a of the driven member 14, such a rotation of the eccentric cam 12 will be converted into a reciprocating linear motion in the up-and-down direction (arrow A direction in FIG. 5) of the stroke S (=2ε) of the rod 13 via the driven member 14. Namely, the rotation of the output shaft 8a of the motor 8 is converted into a reciprocating linear motion of the rod 13 in the up-and-down direction by virtue of the first mechanism.

Then, the reciprocating linear motion of the rod 13 in the up-and-down direction is converted into the reciprocating rotary motion of the head part 3 (mounting table 5) by virtue of the second mechanism as described below.

Namely, when the rod 13 is moved upward by a stroke S from a neutral state shown in FIG. 6(a), the swing arm 16 will swing in an arrow direction (counterclockwise direction) about the swing shaft 18, as shown in FIG. 6(b). For this reason, the head part 3 connected to the swing arm 16 via the roller 17 will rotate in an arrow direction (clockwise direction) about the shaft 15 by an angleθshown in the figure. At this time, the roller 17 provided at the front end of the swing arm 16 is caused to slide radially outward while rolling in the long hole 5a of the mounting table 5 provided in the head part 3.

On the contrary, when the rod 13 is moved downward by the stroke S from the neutral state shown in FIG. 6(a), the swing arm 16 will swing in the arrow direction (clockwise direction) about the swing shaft 18, as shown in FIG. 6(c). For this reason, the head part 3 (mounting table 5) connected to the swing arm 16 via the roller 17 will rotate in an arrow direction (counterclockwise direction) about the shaft 15 by an angleθ. At this time, the roller 17 provided at the front end of the swing arm 16 is caused to slide radially outward while rolling in the long hole 5a of the mounting table 5. In this embodiment, the angleθ is set to be 45 degrees.

As described above, the reciprocating linear motion of the rod 13 in the up-and-down direction is converted into the reciprocating rotary motion of the head part 3 within a predetermined range of an angle 2θ (=90°) by virtue of the second mechanism. Therefore, when the user holds the electric tooth surface cleaning device 1 by hand and presses the ON/OFF switch 4 to start an ON operation, the motor 8 can be started, and the rotation of its output shaft 8a can be converted into a reciprocating rotary motion centering on the shaft 15 of the head part 3 (mounting table 5), by virtue of the first mechanism and the second mechanism.

In the above state, when the user inserts the head part 3 side of the electric tooth surface cleaning device 1 into the mouth and moves the tooth surface cleaning tool 100-2 of the reciprocating head part 3 (mounting table 5) while abutting the tool against the surface of the tooth, dirt such as tartar attached to the tooth surface can be easily and effectively removed by the tooth surface cleaning tool 100-2.

In addition, when the user presses the ON/OFF switch 4 again after the tooth dirt removal operation of the electric tooth surface cleaning device 1 is finished, the power supply from the battery 7 to the motor 8 is cut off, and the rotations of the motor 8 and the head part 3 (mounting table 5) will stop.

The embodiments of the present invention have been described above, but the present invention should not be limited to the above embodiments, and various modifications can be made within the scope of the technical ideas described in the claims, specification and drawings. For example, though in the above embodiment, the mounting table 5 of the head part 3 and the tooth surface cleaning tool 100-2 are rotated or reciprocated to remove dirt attached to the tooth surface, it is also possible to at the same time apply a high-speed vibration (high-frequency vibration) such as ultrasonic vibration to the mounting table 5 of the rotating or reciprocating head part 3 and the tooth surface cleaning tool 100-2.

1. A tooth surface cleaning tool, characterized in that the cleaning tool is formed by heating and pressurizing a melamine resin foam sponge containing a liquid toothpaste, followed by drying the foam sponge in a compressed state.

2. The tooth surface cleaning tool according to claim 1, wherein, the liquid toothpaste contains polyphosphate.

3. The tooth surface cleaning tool according to claim 1, wherein, the liquid toothpaste contains polyethylene glycol.

4. The tooth surface cleaning tool according to claim 1, wherein, the liquid toothpaste contains a flavoring agent.

5. The tooth surface cleaning tool according to claim 1, wherein, the liquid toothpaste contains a fluorine compound.

6. The tooth surface cleaning tool according to claim 1, characterized in that: the melamine resin foam sponge is dried through vacuum drying or freeze drying.

7. The tooth surface cleaning tool according to any one of claim 1, characterized in that the melamine resin foam sponge is compressed into a volume of about ¼ of an original sponge volume by virtue of pressurization.

8. An electric tooth surface cleaning device for cleaning teeth, comprising:
a main body portion having a main body case and a tapered neck portion extending from one end of the main body case;
a head part rotatably arranged at the front end of the neck portion;
a tooth surface cleaning tool detachably mounted on the mounting table of the head part;
a battery and an electric motor built into the main body case;
a conversion mechanism for converting the rotation of the electric motor into a reciprocating rotary motion of the mounting table;
wherein
the tooth surface cleaning tool is a cleaning tool described in claim 1.

9. The electric tooth surface cleaning device according to claim 8, wherein
the electric tooth surface cleaning device includes an attachment means for detachably attaching the tooth surface cleaning tool to the mounting table,
the attachment means is a touch fastener.

10. The electric tooth surface cleaning device according to claim 8, wherein the conversion mechanism for converting the rotation of the motor into the rotation of the mounting table is composed of bevel gears for converting the rotation direction of the output shaft of the motor into a direction perpendicular to the output shaft.

11. The electric tooth surface cleaning device according to claim 8, characterized in that: the conversion mechanism for converting the rotation of the motor into the reciprocating rotary motion of the mounting table, comprises:
a first mechanism that converts the rotation of the output shaft of the motor into a reciprocating linear motion of a rod;
a second mechanism which converts the reciprocating linear motion of the rod into a swing motion of the swing arm.

12. The electric tooth surface cleaning device according to claim 11, wherein:
the first mechanism comprises a gear combined with the output shaft of the motor, a ring gear engaged with the gear, an eccentric cam with an eccentric point from the rotation center of the ring gear serving as rotation center, and a driven member with a long hole engaged with the eccentric cam;
the second mechanism comprises a swing arm, the swing end of which is rotatably fitted in a long hole formed in the radial direction of the mounting table, one point of the base end is rotatably connected with the front end of the rod, and the other point of the base end is swing-supported about the swing shaft.
